(19) United States
(12) Patent Application Publication
(10) Pub. No.: US 2018/0204113 A1
(43) Pub. Date: Jul. 19, 2018

(54) INTERACTION ANALYSIS AND PREDICTION BASED NEURAL NETWORKING

(71) Applicant: eBay Inc., San Jose, CA (US)

(72) Inventors: DANIEL GALRON, New York, NY (US); YURI MICHAEL BROVMAN, New York, NY (US); BENJAMIN ELIOT KLEIN, San Jose, CA (US); ANDREW DROZDOV, New York, NY (US); HONGLIANG YU, Edison, NJ (US)

(21) Appl. No.: 15/869,364

(22) Filed: Jan. 12, 2018

Related U.S. Application Data
(60) Provisional application No. 62/446,283, filed on Jan. 13, 2017.

(51) Int. Cl. G06N 3/04; G06K 9/62; G06N 7/00; G06Q 30/06

(52) U.S. Cl. CPC G06N 3/0472; G06Q 30/0631; G06N 7/005; G06K 9/6256

(57) ABSTRACT

Embodiments of the present invention provide systems, methods, and computer storage media directed to generating interaction and network asset association predictions. Recommendations for network assets in response to interactions with other network assets may be provided. Initially, a pair of items, including a seed asset and a candidate asset, is received. Each word in the seed and candidate titles, each aspect, and the categories may be embedded into a k-dimensional vector space. The embedding may then be aggregated to construct an n-dimensional vector representing a seed asset and an n-dimensional vector representing a candidate asset which are used to determine and generate a probability that the seed asset and the candidate asset are contemporaneously operated upon by the same user. The system may then rank recommendation candidates by a co-interaction probability output of the neural network system.

### CROSS-REFERENCE TO RELATED APPLICATIONS

This application claims the benefit of U.S. Provisional Application Ser. No. 62/446,283, entitled “Interaction Analysis and Prediction Based Neural Networking”, filed Jan. 13, 2017, herein incorporated by reference in its entirety.

### TECHNICAL FIELD

The subject matter disclosed herein generally relates to the technical field of special-purpose machines that facilitate analysis of interactions and prediction within a network service, including software-configured computerized variants of such special-purpose machines and improvements to such variants, and to the technologies by which such special-purpose machines become improved compared to other special-purpose machines that facilitate predicting user interactions based on language parsing and predicting interrelations between network assets.

### BACKGROUND

Conventional behavioral analysis systems aggregate behavioral signals of an individual at a paired network asset level. These systems aggregate behavioral signals and interaction data on the network asset level due to the ability to identify interactions with paired network assets in a single contemporaneous operation. These behavioral analysis systems often identify contemporaneous operations based on a user identification included in the operation or by an identification for the network assets in the contemporaneous operation, and rely on a number of users performing the same operation. These behavioral analysis systems often make determinations on network assets based merely on a number of interactions performed for a given pair of network assets as a proxy for determining a relevance among network assets.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments described in the present disclosure are generally directed towards generating interaction and network asset association predictions. Recommendations for network assets in response to interactions with other network assets may be provided. For example, the systems and methods may generate complementary recommendations for items or publications based on items or publications with which a user is currently or has recently interacted. Initially, a pair of items, including a seed asset and a candidate asset, is received. Each word in the seed and candidate titles, each aspect, and the categories may be embedded into a k-dimensional vector space. The embedding may then be aggregated to construct an n-dimensional vector representing a seed asset and an n-dimensional vector representing a candidate asset. The n-dimensional vector for the seed asset and the n-dimensional vector for the candidate asset are accessed or received by one or more components of the system to determine and generate a probability that the seed asset and the candidate asset are contemporaneously operated upon (e.g., purchased) by the same user. In such instances, the system may obtain, as input, a recently purchased item or accessed publication and information relating to or contained within the item or publication. The system may then rank recommendation candidates by a co-interaction probability output of the neural network system. The recommendations generated by the system may display items that complement a recent purchase or interaction or are thematically or stylistically compatible with a recent purchase or interaction.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments;

FIG. 2 is a block diagram illustrating an example interaction prediction system, according to some example embodiments;

FIG. 3 is a flow chart illustrating an example method, according to various embodiments;

FIGS. 4-6 are block diagrams illustrating neural networking architectures, according to some example embodiments;

FIG. 7 is a block diagram illustrating an example of a software architecture that may be installed on a machine, according to some example embodiments; and

FIG. 8 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

Example methods, systems, and computer programs are directed to adding new features to a network service such as image recognition, image signatures generation, and category prediction performed from an input image. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Conventional behavioral analysis systems may aggregate behavioral signals at a network asset level or a contemporaneous operation level, identifying users who interact with two network assets in an attempt to predict behaviors or interactions of other users with other network assets. Conventional behavioral analysis systems are not designed for the diversity, scale, and depth of information associated with network assets available for search and interaction. Often, these systems using user interactions lack context and relevance supplied in a search, interaction, or within the information associated with the network assets. Often irrelevant results are shown when these systems attempt to predict behavior, while more contextually appropriate results may be buried among the noise created by thousands of search results.

In some embodiments, systems and methods of the present disclosure describe interaction analysis, in conjunction with network asset analysis, to generate interaction and network asset association predictions. The systems and methods may provide recommendations for network assets in response to interactions with other network assets. For example, the systems and methods may generate complementary recommendations for items or publications based on items or publications with which a user is currently or has recently interacted. Complementary recommendations may enable users to seamlessly transition between interactions by assisting infrequent users to interact (e.g., read, purchase, rent, or share) with network assets, items, publications, or other resources more often. Complementary recommendation systems may enable recurring users to identify a suitable or desired network asset based on their interactions, interactions of other users, and information and associations determined among a plurality of network assets. Complementary recommendation systems may also inspire users to find additional network assets related to a network asset with which the user is currently interacting or has recently interacted. In some instances, the systems and methods of the present disclosure employ neural network architectures to perform predictive analysis on one or more inputs described herein. For example, neural network architectures used in the present disclosure may include deep neural network architectures.

In some embodiments, systems for a deep neural networking architecture and training methods are disclosed. The systems and methods may enable estimation of contemporaneous interactions with network assets lacking historical interaction context. For example, in some instances, the systems and methods generate recommendations of complementary items or assets for interaction by a user of the system. In some embodiments, a user interacting with the system may have purchased an item. The systems and methods disclosed herein surface other items to the user, where the items are either complementary to the initial item (e.g., a seed item) or where they are thematically consistent with the seed item.

In generating predictions for contemporaneous assets, the systems and methods of the present disclosure receive a pair of items, including a seed asset and a candidate asset. The systems of the present disclosure may embed each word in the seed and candidate titles, each aspect, and the categories into a k-dimensional vector space. The embedding may then be aggregated to construct an n-dimensional vector representing a seed asset and an n-dimensional vector representing a candidate asset. The n-dimensional vector for the seed asset and the n-dimensional vector for the candidate asset are accessed or received by one or more components of the system to determine and generate a probability that the seed asset and the candidate asset are contemporaneously operated upon (e.g., purchased) by the same user. In such instances, the system may obtain, as input, a recently purchased item or accessed publication and information relating to or contained within the item or publication.

The system may then rank recommendation candidates by a co-interaction probability output of the neural network system. The recommendations generated by the system may display items that complement a recent purchase or interaction or are thematically or stylistically compatible with a recent purchase or interaction. Where the recommendation is complementary, for example, the recommendation may include a compatible camera bag, memory card, or wrist strap to someone who just bought a camera. Where the recommendation is thematically compatible, for example, the recommendation may include a stylistically compatible shirt to someone who purchased a dress, or recommended a bobble head of a sports figure to someone who just bought a sport figure's trading card.

The neural network may be trained using a gradient backpropagation algorithm. A training methodology for the backpropagation algorithm may selectively identify and use positive and negative examples for training parameters of the neural network. In some instances, the training methodology samples assets according to a language model probability estimate of the titles of assets. In some instances, an architecture of the neural network system may be configured for predetermined network asset data, aggregating information contained in titles, aspects, and categories in a manner particular to characteristics of the predetermined network asset data. In some instances, the training methodology and the neural networks are configured to predict co-views of network assets. The training methodology and the neural networks of the present disclosure may also be used for search relevance, estimating a probability of an interaction (e.g., a click, a purchase of an item, or an item being provided in a search query result).

Recommendations of the systems and methods of the present disclosure may be generated in multiple positions within a page, website, user interface or other presentation to the user, as well as in other communications venues, such as email and mobile messaging. In some embodiments, the systems and methods of the present disclosure may surface recommendations on pages relating to recent purchases of a user interacting with a purchasing system. The surfacing of recommendations may include a checkout page, a personalized home page within a publication system, and other suitable user interfaces.

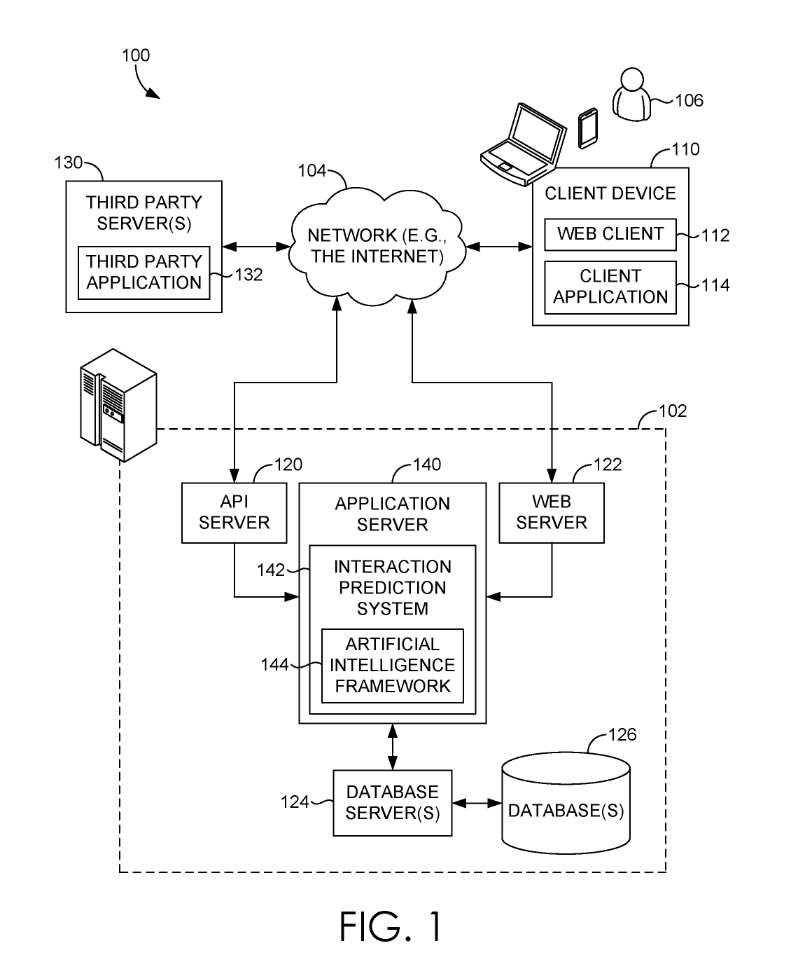

FIG. 1 is a block diagram illustrating a networked system, according to some example embodiments. With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device(s) 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device(s) 110, then the e-commerce site application is configured to locally provide the user interface and at least some of the functionalities with the application are configured to communicate with the networked system 102, on an as needed basis, for data or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application server(s) 140 host an interaction prediction system 142, which includes an artificial intelligence framework 144, each of which may comprise one or more modules or applications and each of which may be embodied as hardware, software, firmware, or any combination thereof.

The application server 140 is, in turn, shown to be coupled to one or more database servers 126 that facilitate access to one or more information storage repositories or databases 126. In an example embodiment, the databases 126 are storage devices that store information to be posted (e.g., publications or listings) to one or more of the networked system 102 and the interaction prediction system 142. The databases 126 may also store digital item information in accordance with example embodiments.

Additionally, a third-party application 132, executing on third-party servers 130, is shown as having programmatic access to the networked system 102 via the programmatic interface provided by the API server 120. For example, the third-party application 132, utilizing information retrieved from the networked system 102, supports one or more features or functions on a website hosted by the third party. The third-party website, for example, provides one or more promotional, marketplace, or payment functions that are supported by the relevant applications of the networked system 102.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 102 and the artificial intelligence framework system 144 could also be implemented as standalone software programs, which do not necessarily have networking capabilities.

The web client 112 may access the interaction prediction system 142 via the web interface supported by the web server 122. Similarly, the programmatic client 116 accesses the various services and functions provided by the interaction prediction system 142 via the programmatic interface provided by the API server 120.

Additionally, a third-party application(s) 132, executing on a third-party server(s) 130, is shown as having programmatic access to the networked system 102 via the programmatic interface provided by the API server 114. For example, the third-party application 132, utilizing information retrieved from the networked system 102, may support one or more features or functions on a website hosted by the third party. The third-party website may, for example, provide one or more promotional, marketplace, or payment functions that are supported by the relevant applications of the networked system 102.

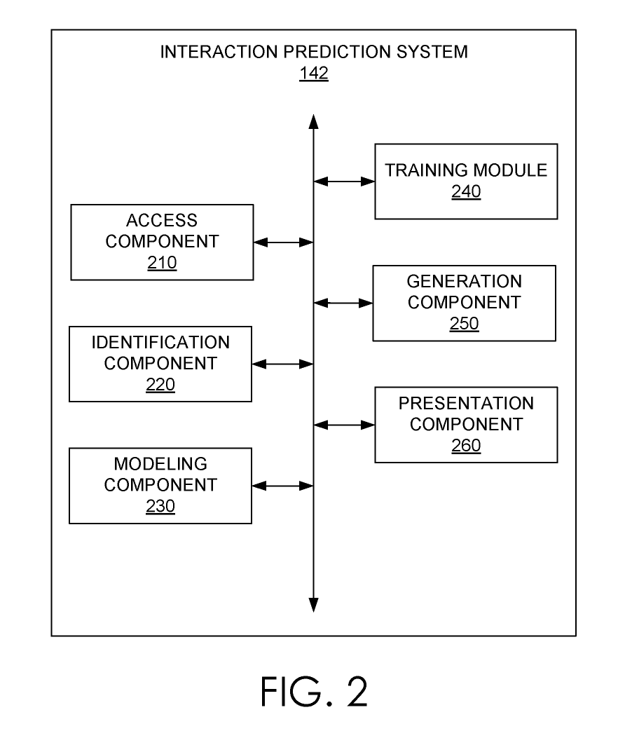

FIG. 2 is a block diagram illustrating the interaction prediction system 142 in more detail, in accordance with one or more embodiments of the present disclosure. The interaction prediction system 142 is shown as including an access component 210, an identification component 220, a modeling component 230, a training component 240, a generation component 250, and a presentation component 260 all configured to communicate with one another (e.g., via a bus, shared memory, or a switch). Any one or more of the components described herein may be implemented using hardware (e.g., one or more processors of a machine) or a combination of hardware and software. For example, any module or component described herein may configure a processor (e.g., among one or more processors of a machine) to perform operations for which that component is designed. Moreover, any two or more of these components may be combined into a single component, and the functions described herein for a single component may be subdivided among multiple components. Furthermore, according to various example embodiments, components described herein as being implemented within a single machine, databases 126, or device (e.g., client device 110) may be distributed across multiple machines, databases 126, or devices.

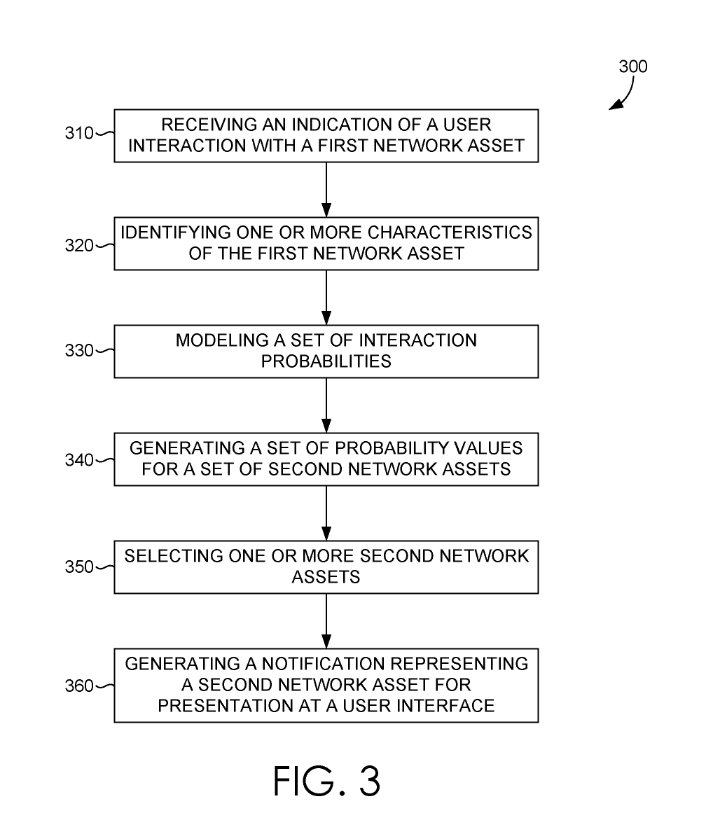

FIG. 3 is a flow chart of operations of the interaction prediction system 142 in performing a method 300 of generating notifications for second network assets contemporaneous with and based on user interactions with a first network asset, according to some example embodiments. Operations of the method 300 may be performed by the interaction prediction system 142, using components described above with respect to FIG. 2.

In operation 310, the access component 210 receives or otherwise accesses an indication of a user interaction with a first network asset. The first network asset may be one or more of a database (e.g., the database 126) or a resource, such as a publication, an item in a repository of item listings, a portion of data stored on a database, or any other resource configured for user interaction. The indication of the user interaction may include an interaction type designating a type for the user interaction.

In some embodiments, where the interaction prediction system 142 is determining predictions of complementary network assets in the form of items for purchase represented by publications, the interaction prediction system 142 may use the first network asset as a seed item. The seed item may be used to generate complementary recommendations, as described in one or more embodiments of the method 300. In some instances, items associated with the networked system 102 or available for prediction and behavioral analysis by the interaction prediction system 142 may be volatile. In such instances, a volatility of items may be due to a turn over or sale rate, a unique or singular nature of items, or any other suitable cause leading to sparsity of a typical item to item co-purchase matrix. For example, items that are not provided with a large enough quantity or are good until cancelled may only be purchased by a single user. These instances may prohibit accumulation of co-purchase signals for a given item, or item types. The volatility may affect availability of a seed item for co-purchase, and analysis by co-purchase. In such instances of volatility, the interaction prediction system 142, as will be described in more detail below, may map listing items to static entities. The static entities may be associated with categorical identifications, characteristics, inclusion of specified keywords, or any other suitable entity.

In operation 320, the identification component 220 identifies one or more characteristics of the first network asset. In some embodiments, the one or more characteristics comprise one or more of a title, an aspect, and a category designation. In some instances, the one or more characteristics represent data contained in a resource stored on a database accessible by the identification component 220. In some instances, the one or more characteristics are provided to or accessed by the access component 210 upon interaction of a client device 110 of a user with the first network asset. In some embodiments, the characteristics may be associated with static entities, as described above, to represent relatively singular or unique network assets associated with or available for modeling to the interaction prediction system 142.

In operation 330, the modeling component 230 models (e.g., generates one or more models) a set of interaction probabilities for a set of second network assets. The model may be performed in response to and based on the interaction type and the one or more characteristics of the first network asset.

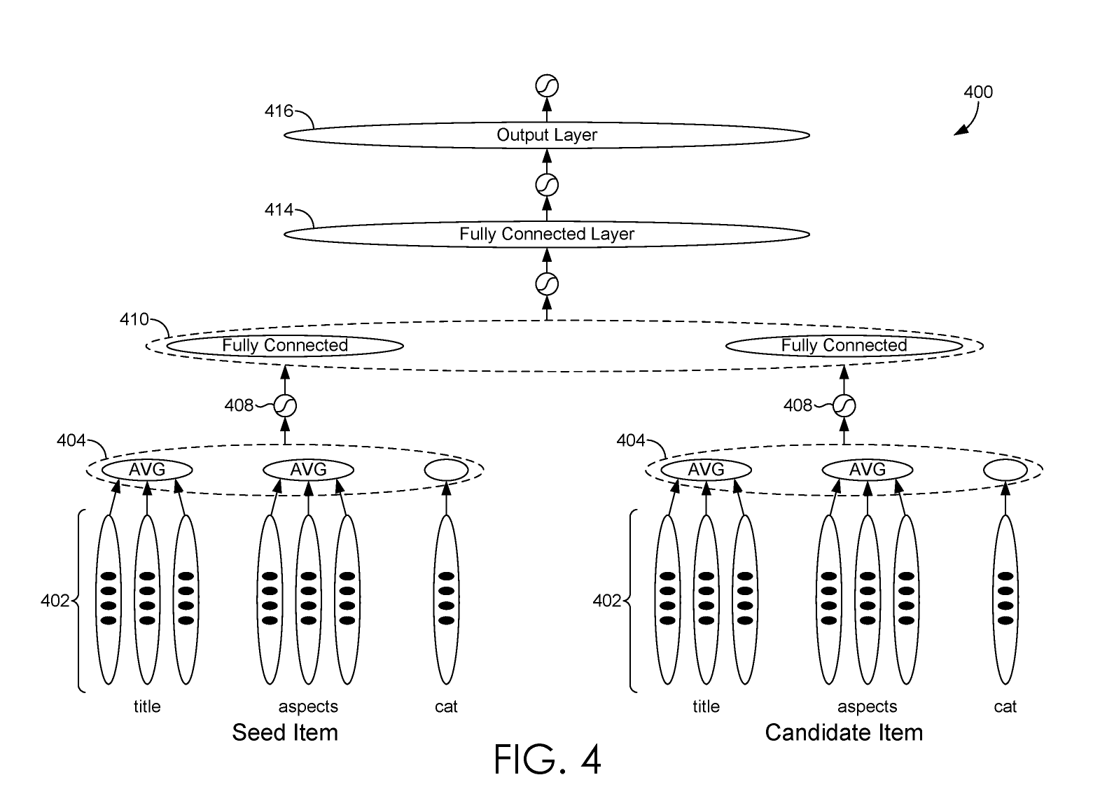

In some embodiments, as described above with respect to volatile item inventories, the modeling component 230 may initially identify co-interaction (e.g., co-purchase, co-bids, co-views, subsequent views, views-after purchase, combinations thereof, or other suitable co-interactions) frequencies between static entities associated with the first network asset and one or more additional network assets. The one or more additional network assets may be considered or provided as an initial input in generating the set of second network assets. For example, an architecture for a neural network and received inputs is shown in FIG. 4. In some embodiments, the co-interaction frequencies may be an initial model representing relevance between a seed item and a potential recommendation candidate item. In some embodiments, static entity types (e.g., sources) may vary in terms of item or network asset coverage, granularity, and relevance.

When modeling interaction probabilities for the set of second network assets, and subsequently surfacing a set of recommendations for a seed item, the modeling component 230 may initially determine categories or other characteristics from which the set of second network assets should be drawn or with which the set of second network assets should be associated. In some of these embodiments, the modeling component 230 uses a category-level co-interaction model, which may be previously generated or may be contemporaneously or dynamically generated. The category-level co-interaction model may return, for each seed category (e.g., categories associated with the seed item or first network asset), a list of a top k most co-interacted (e.g., co-purchased) categories within a given period of time. In some instances, the period of time may be dynamic, based on one or more of the frequency of interaction, a time (e.g., a date, an hour, a time period, a duration, or a time range) associated with the interaction received in operation 310, a recency of interactions among the given categories, or any other suitable information. One or more of the top k most co-interacted categories may include the seed category. One or more of the top k categories may be used to constrain network assets or items included in the set of second network assets. For example, one or more of the top k categories may be used to constrain the network assets under consideration for inclusion in the set of second network assets. The one or more top k categories may also be used to constrain the network assets of the set of second network assets which are eventually surfaced in a recommendation or notification generated by one or more components of the interaction prediction system 142.

In some embodiments, the modeling component 230 employs a waterfall approach. In such embodiments, the modeling component 230 may initially attempt to surface or identify associations from relative high quality sources having co-interaction frequencies above a predetermined or dynamic threshold. The modeling component 230 may then fall back to lower quality sources if the seed item does not map to a static entity within a source or a threshold number of static entities or sources. In some instances, the modeling component 230 may fall back on the lower quality sources if no candidate static entities are co-interacted (e.g., co-purchased) with the seed static entity. For each candidate static entity, having a relation or co-interaction with the seed static entity of the first network asset, the modeling component 230 may select or initially identify items (e.g., network assets) that map to the candidate static entity for consideration and inclusion in the set of second network assets. Further, the interaction prediction system 142 may use identified items, mapped to the candidate static entity, for surfacing to a user in response to the interaction accessed in operation 310.

In some embodiments, one or more sources may define static entities. In such embodiments, sources may comprise product identifications, good-til-cancelled (GTC) items and pseudo-product identifications, multi-aspect sets, related aspects, and basic sources. Product identifications may initially map network assets associated with product identifications to those product identifications. The product identification source may then use a normalized co-interaction frequency between product identifications to identify and retrieve one or more network assets, with which the first network asset was most co-interacted. For the top k most co-interacted network assets, the modeling component 230 may select one network asset to include in the set of second network assets, resulting in k network assets in the set of second network assets. In some instances, product identifications may amount to a percentage of complementary impressions, such as six percent of complementary impressions.

GTC items and pseudo-product identification sources may be collected into a single GTC source. The GTC source may map each multi-quantity or good-til-cancelled network assets to its own static entity to create pseudo-product identifications. The modeling component 230 may use normalized co-interaction frequencies between pseudo-product identifications to fetch, retrieve, or select the most co-interacted network assets or static entities, with respect to the first network asset or the seed static entity. In some instances, product identifications may amount to a percentage of complementary impressions, such as seventeen percent of complementary impressions. In some instances, product identification and pseudo product identification sources, used alone by the modeling component 230, may limit coverage of impressions while providing relatively higher performing (e.g., interactions resulting from a recommendation) recommendations. In some instances performance may be measured by relative purchase-through rates.

The multi-aspect set sources may map network assets to a power set of their aspects. The modeling component 230 may use a normalized co-interaction frequency between aspect sets to select a top k most co-interacted aspect sets, with respect to the seed static entity. The modeling component 230 may select a subset of network assets within the selected aspect sets for inclusion in the set of second network assets. In some instances, product identifications may amount to a percentage of complementary impressions, such as six percent of complementary impressions. In some instances, multi-aspect set sources, used alone by the modeling component 230, may limit coverage for the source, based on the source employing a power set of aspects.

The related aspect source may map each seed item (e.g., first network asset) to a single top aspect for a specified category. The modeling component 230 may use a normalized co-interaction frequency between the top aspects to select the top k most co-interacted aspects, with respect to the first network asset. In some instances, product identifications may amount to a percentage of complementary impressions, such as twenty-six percent of complementary impressions. In some instances, related aspect source, used alone by the modeling component 230, may limit influence of stylistic information for network assets. Mapping static entities based on related aspects may enable course mapping, such as by using single instances of aspects. The related aspect source mapping may result in broader inclusion of network assets.

The basic source may map each item or network asset to its category. The modeling component 230 may use a normalized co-interaction frequency between categories of network assets and the first network asset to select the top k most co-interacted categories. The modeling component 230 may then select the most popular (e.g., highest frequency) network assets from each category for inclusion in the set of second network assets. In some instances, product identifications may amount to a percentage of complementary impressions, such as forty percent of complementary impressions. The basic source, used alone by the modeling component 230, may enable broad inclusion of network assets. For example, broad leaf categories included in basic source mapping may include broad categories returning a large number of network assets and a broader categorical scope of the included network assets.

In some embodiments, the modeling component 230 selects network assets for inclusion in the set of second network assets using one or more sources. In embodiments using multiple mapping sources, the modeling component 230 may employ an iterative modeling approach, generating an interaction model using progressively narrower or progressively broader sources. In some instances, an output from a first iteration of an interaction model, using a first source, may be used as an input, filter, or constraint for a subsequent iteration using a subsequent broader or narrower source. In some instances, the modeling component 230 selects sources, iteration approaches, or combinations thereof based on a trained model scheme. In some embodiments, the modeling component 230 selects sources, iterations, and combinations thereof dynamically based on one or more characteristics of the interaction received in operation 310, characteristics of the first network asset, characteristics of the sources, combinations thereof, or any other suitable input.

In some embodiments, the modeling component 230 models interaction probabilities, to generate item to item recommendations, with deep neural networks. In such embodiments, the modeling component 230 generates the model without explicitly performing mapping operations prior to model generation. The modeling component 230 may iteratively generate estimations of relevance of recommendation candidates to the seed item (e.g., first network asset) using the one or more characteristics of the first network asset. The estimations of relevance may be generated directly using network asset titles, aspects, categories, and other information as input features to one or more deep neural network components of the modeling component 230. In some instances, as described in more detail below, a model is trained to maximize (e.g., theoretically maximize) a relevance measure between a seed network asset (e.g., the first network asset) and a recommendation candidate, such as a network asset determined for inclusion in the set of second network assets.

In some embodiments, an iterative approach to generating the model using the neural network components of the modeling component 230 enables and includes the modeling component 230 learning which features (e.g., characteristics of network assets, interactions, or combinations thereof) are more or most indicative of a co-interaction. The learning of the modeling component 230 may be in conjunction with or informed by the static entities or groupings. In some embodiments, the modeling component learns which features are indicative of co-interaction without employing static entities or groupings. In some instances, when aspect coverage is sparse or course (e.g., sparse or course beyond a predetermined or dynamic threshold), the modeling component 230 extracts information from titles, identifications, or designations of network assets (e.g., the first network asset and potential candidate network assets). The modeling component 230 may also learn semantic representations of network assets (e.g., items) based on titles, identifications, or designations of the network assets and aspects of or associated with the network assets. The modeling component 230 may use the semantic representations to identify similar network assets, such as by using k nearest neighbor analysis, algorithms, or operations on the learned network asset representations. The modeling component 230 may also incorporate a diversification factor into recommendations or selections of network assets for inclusion in the set of second network assets using the semantic representations. In such instances, the modeling component 230 may apply a greedy ranking on representation vectors for the network assets.

In some embodiments, the modeling component 230 initially estimates a conditional probability of a co-interaction event occurring given the seed network asset and a recommendation candidate asset (e.g., a network asset of the set of second network assets). The probability may be represented as P(CP∈{0,1}|xₛ,xᵣ), where xₛ is the seed network asset and xᵣ is the recommendation candidate asset. In some instances, the conditional probability may not be symmetric, such that P(CP=1|xₛ,xᵣ)≠P(CP=1|xᵣ,xₛ).

In operation 340, the generation component 250 generates a set of probability values for the set of second network assets. In some instances, the generation component 250 operates in cooperation with the modeling component 230 to generate the set of probability values. In some embodiments, each probability value indicates a likelihood of user interaction with a second network asset based on the modeled set of interaction probabilities.

In some embodiments, the generation component 250 applies the model, generated by the modeling component 230 in operation 330, to generate the set of probability values. The generation component 250 may incorporate a heuristic filter. The heuristic filter may remove, devalue, or otherwise modify probability values for network assets produced by application of the model. In some instances, the heuristic filter removes, devalues, or suppresses network assets determined to be or indicated as being dissimilar from network assets sampled during training of the model, described in more detail below.

In operation 350, the generation component 250 selects one or more second network assets of the set of second network assets. Selection of the one or more second network assets may be based on the set of probability values.

In operation 360, one or more of the generation component 250 and the presentation component 260 generate a notification representing a second network asset for presentation at a user interface. In some embodiments, presentation of the notification may be performed at the user interface at a time substantially contemporaneous with the user interactions with the first network asset.

FIG. 4 is a block diagram illustrating a neural network architecture 400 of the interaction prediction system 142, according to some example embodiments. As shown in FIG. 4, input to the neural network 400 may consist of titles, identifications, and designations of network assets (e.g., items). The input may also include aspects and categories for network assets or pairs of network assets. As shown, the network may be composed of five layers. In a first layer, tokens representing or included in titles, aspects, and categories of two network assets are retrieved in an embedding table. The modeling component 230 retrieves embedding vectors 402 associated with the tokens. In some instances, an average pooling layer 404 performs an element-wise averaging of the title vectors and aspects for each network asset. The averaged vectors may then be concatenated together for the seed network asset and the candidate network asset. The averaged and concatenated vectors may be passed through a non-linearity function or layer 408, such as a hyperbolic tangent function or a neural network layer employing a hyperbolic tangent function, and be fed through a fully connected layer 410. The averaged and concatenated vectors or results produced by the fully connected layer may be fed through another non-linearity function or layer. The pass through the subsequent fully connected layer may yield a semantic vector representation for the seed item and a semantic vector representation for the candidate item. The two representations may then be concatenated and fed through two fully connected layers 414, 416 with non-linearities. The output of the two fully connected layers 414, 416 may represent a prediction for a probability of a co-interaction (e.g., a co-purchase) of the seed network asset and the candidate network asset.

In some embodiments, to train the model, the training component 240 may receive or access a set of training data to generate an initial or trained model. In some instances, the training component 240 trains the initial model independently. The training component 240 may also train the initial model in cooperation with the modeling component 230. In some instances, the training component 240 is a part or component of the modeling component 230. In such embodiments, the training component 240 may be a component configured to be isolated from operations of the modeling component 230 performed outside of training or performed on data determined to be excluded from the set of training data.

The training component 240 may train the initial model to predict a probability of interaction (i.e., a scoring function) with a recommended candidate network asset xᵣ given an initial interaction with a seed network asset xₛ. The scoring function may be represented as a cosine similarity estimate or a conditional probability P(xᵣ|xₛ). The scoring function generated by the initial model, or the model trained by the modeling component 230, may be used to rank, select, or generate probability values indicative of co-interactions between a given first network asset and a given second network asset. In some instances, the scoring function may indicate a likelihood of purchase, bidding, viewing, selection, reading, or any other suitable interaction or combination of interactions.

Similar to the manner described above, the trained model may estimate probability of co-interaction events occurring given a seed network asset and a recommendation candidate network asset. The estimated probability may be represented using Equation 1, below.

P(CP∈{0,1}|xₛ,xᵣ) Equation 1

In some embodiments, the conditional probability is not symmetrical, as represented in Equation 2, below.

P(CP=1|xₛ,xᵣ)≠P(CP=1|xᵣ,xₛ) Equation 2

In some embodiments, the model is trained using a skip-gram model for learning neural word embedding. The skip-gram model may predict proximity of words, such as a central word and a context word, using negative and positive samples. In some instances, a per-example loss for training the model may be represented below as equation 3.

log σ(ƒ(\vec{w},\vec{c}))+k· [symbol] _{c′˜P}_{_{D}} log σ(−ƒ(\vec{w},\vec{c}′)) Equation 3

In Equation 3, σ may be a sigmoid function. An expectation for the sigmoid function may be over the unigram distribution of words in the corpus. As shown in Equation 3, \vec{w} and \vec{c} may be learned vectors for words w and c. In embodiments using the skip-gram model, a pre-activation function ƒ is the dot product \vec{w}·\vec{c}. Optimizing (e.g., theoretically optimizing) the per-example loss may adjust model parameters to assign high probability to words and contexts sampled from the corpus distribution and low probability to words and contexts that were sampled from a noise distribution.

In some embodiments, the training component 240 employs modeling differing from the skip-gram model. In some such embodiments, the training component 240, given a data set of pairs of network assets with which a user interacted in a given time period may generate predictions on whether the two network assets are drawn from a distribution underlying the training dataset. In some embodiments, the two network assets may be constrained by a single category or two or more related categories. In some instances, the prediction of the model generated by the training component 240 may be represented using Equation 4, below.

P(CP=1|xₛ,xᵣ)=σ(ƒ(xₛ,xᵣ)) Equation 4

The model providing a prediction or probability represented by Equation 4 may define a function as a multi-layer neural network, taking words as input such as words in titles, aspects, categories, and other data in a pair of network assets or associated therewith. A per-example loss for the model generated in these embodiments may be represented in Equation 5, shown below.

log σ(ƒ(φ(xₓ),φ(xᵣ)))+k· [symbol] _{x′}_{ᵣ}_{˜P}_{_{D}} log σ(−ƒ(φ(xₛ),φ(x′ᵣ))) Equation 5

In Equation 5, the φ(x) may be a feature function extracting a feature vector from an item or network asset x. An expectation of the feature function may be taken over a distribution of items or network assets in a set of frequently co-interacted categories to the seed network asset xₛ.

In some embodiments, the set of training data may be divided into positive examples and negative examples. In such embodiments, positive examples may be constructed as pairs by considering all pairs of network assets with co-interactions by a same user. The positive examples or co-interactions from the user may be constrained by related categories or the related categories model described above. In some instances, each row in an interaction table may include one or more of an interaction indication, a category identification, a network asset identification, and a user identification. Rows in the interaction table may be grouped by a user identification, in some instances. For each group of interactions by a user, a Cartesian product of network assets may be generated, such that, for each pair of network assets (xₛ, xᵣ), an interaction date or time of xₛ precedes an interaction date or time for xᵣ. In some embodiments, the training data may further be filtered by including only pairs of network assets using certain predetermined constraints. For example, positive examples in training data may be constrained to include pairs of network assets, with which the user performed interactions, where a leaf category of xᵣ is one of the top ten, top twenty, top one hundred, or any other suitable threshold of most co-interacted categories with a leaf category of xₛ. In some instances, such pairs may be extracted from a year's worth, or any other selected time period, of interactions recorded in the interaction table.

The negative examples, may comprise network assets that were live on the networked system 102, the third party server 130, or any other database, system, or server accessibly by the interaction prediction system 142. The live nature of the network assets for negative examples may be constrained by a time period or range from which positive examples were selected. For each positive example pair (xₛ, xᵣ) on which the initial model is trained, the training component 240 may sample k items x′ᵣ. The category of x′ᵣ may be one of a top number (e.g., determined by a specified predetermined or dynamic threshold) of most co-interacted categories with the category of xₛ.

In some embodiments, the initial model is influenced by a distribution of negative examples sampled by the training component 240. In some embodiments, the training component 240 samples negative examples uniformly across network assets subject to category constraints described above. In some instances, the training component 240 samples network assets according to a probability of titles of the network assets occurring under a model estimated over a corpus of network asset titles. In some example embodiments, the training component 240 samples negative examples according to a square root of a probability of the titles, designations, or identifications of the network assets occurring under a model estimated over a corpus of network asset titles.

The training component 240 may train the initial model via a backpropagation algorithm. In some instances, the training component 240 uses minibatch stochastic gradient descent. The training component 240 may regularize the parameters using max-norm regularization. A clipping gradient may perform updates that cause an 12-norm of parameter vectors to exceed a specified threshold (e.g., a predetermined threshold or a dynamic threshold). One or more initial models may be trained for a fixed number of epochs, time periods, or time ranges. The epochs may be determined by how much time the training component 240 spends on training a model or any other suitable metric. In some embodiments, a final trained model is selected by evaluating the one or more initial models generated or trained in each epoch on a held-out validation set. A final model may be selected by the training component 240 or the modeling component 230 where the final model is evaluated as scoring highest using a selected evaluation measure. In some instances, a model for each seed L2 category is trained. For example, for a specified L2 category, the training component 240 may receive and incorporate approximately fifty million distinct positive example training pairs. For each positive example, in some instances, the training component 240 samples k=4 negative examples. Although described with a specified number of positive example training pairs and negative examples, it should be understood that the training component 240 may employ any suitable number of positive and negative training pairs based on a category, an available number of interactions, or any other suitable selection characteristic.

In some embodiments, the model is trained to capture the similarity of implicit feedback between the entities to be recommended. Then, the trained model generates the top-N recommendations for an active user or for a seed item. One common method of capturing the similarity is by computing the pair-wise cosine similarity of implicit feedback vectors. Consider two items s and r. Let \vec{s} and \vec{r} be vectors of dimensionality |U|, where U is the set of users in the system and \vec{s} and \vec{r} are vectors of user feedback. To do so, behavioral similarity can be measured by computing the cosine similarity between these two vectors:

$$sim ( \vec{s} , \vec{r} ) = cos ( \vec{s} , \vec{r} ) = \frac{{\sum }_{i = 1}^{\vert U \vert} {s}_{𝓁} \cdot {r}_{𝓁}}{\sqrt{{\sum }_{i = 1}^{\vert U \vert} {s}_{i}^{2}} \cdot \sqrt{{\sum }_{i = 1}^{\vert U \vert} {r}_{\overline{i}}^{2}}} \qquad Equation 6$$

In the case where the user feedback is implicit, and the vectors \vec{s} and \vec{r} are represented as bit vectors, the cosine similarity is equivalent to the Ochiai coefficient:

$$cos ( \vec{s} , \vec{r} ) = \frac{{\sum }_{i} {1}_{{s}_{i} {Ar}_{i}}}{\sqrt{{\sum }_{i} {s}_{i} \cdot } {\sum }_{i} {r}_{i }} \qquad Equation 7$$

In embodiments, the training component 240 learns a function that can estimate the cosine similarity between the implicit feedback vectors of items, based on content properties of those items. Let I denote the set of all items, t∈I. The training set consists of two sets: a set of item pair co-purchase transactions (sⱼ, rⱼ)∈CP, and a set of purchased items tⱼ∈D. The set CP represents the set of transaction pairs (sⱼ, rⱼ), where each pair represents an event where the same user p purchased both items s∈I, r∈I. Similarly, let the set D represent the set of transactions tⱼ∈D, which is the event that a user j purchased an item tεI. Without loss of generality, assume each user will purchase an item t∈I, or a pair of items (s,r)∈I×I no more than once. The number of times a pair of items (s,r)∈I×I has been purchased by the same user can be defined as:

$${n}_{CP} ( s , r ) = {\sum }_{( x , y ) ϵ CP} ( {1}_{x = s ⋀ y = r} ) \qquad Equation 8$$

The total number of co-purchased pairs is then given by |CP|=Σ_{s,r}(n_{CP}(s,r)). Similarly, the number of times an item t∈I has been purchased is given by:

$${n}_{D} ( t ) = {\sum }_{x ϵ D} {1}_{x = t} \qquad Equation 9$$

and the total number of purchases |D| is given by |D|=Σₛ(n_{D}(s)).

Let h(s,r) be a be a parameterized function (i.e., a model) that estimates the cosine similarity of implicit feedback of items s,r∈I. Given a training set of co-purchased item pairs and purchased items τ=(CP,D), the following cost function over the training set can be defined by:

l=Σ_{(s,r)∈CP}n_{CP}(s,r)log σ(h(s,r))Σ_{s′∈I}Σ_{s′∈i}[{square root over (n_{D}(s′)\sqrt{n_{D}(r′)})} log [1−σ(h(s′,r′))]] Equation 10

where σ is the sigmoid function,

$$σ ( x ) = \frac{1}{1 + {e}^{- x}} .$$

The value of h(s,r) that minimizes this cost function for a given pair (s,r) is the log of the cosine similarity expressed in Equation 7. Assuming the capacity of the model is large enough to allow exact prediction on (s,r) without deviation from the optimum, each h(s,r) can assume a value independently of other (s,r) pairs. Decomposing the loss and calculating it on a single pair of items (s,r), the following function for a pair is realized:

l(s,r)=n_{CP}(s,r)log σ(h(s,r))+{square root over (n_{D}(s)\sqrt{n_{D}(r)} log)}σ(−h(s,r)) Equation 11

Given that 1−σ(x)=σ(−x), the value of h(s,r) that optimizes Equation 11 is identified by taking the partial derivative of l(s,r) with respect to h(s,r):

$$\frac{\partial 𝓁 ( s , r )}{\partial h ( s , r )} = {n}_{CP} ( s , r ) σ ( - h ( s , r ) ) - \sqrt{{n}_{D} ( s ) \sqrt{{n}_{D} ( r )} σ ( h ( s , r ) )} \qquad Equation 12$$

Setting Equation 12 equal to 0 and solving for h(s,r) determines:

$$0 = {n}_{CP} ( s , r ) σ ( - h ( s , r ) ) - \sqrt{{n}_{D} ( s )} \sqrt{{n}_{D} ( r )} σ ( h ( s , r ) ) \\ 0 = {n}_{CP} ( s , r ) \frac{1}{1 + {e}^{h ( s , r )}} - \sqrt{{n}_{D} ( s )} \sqrt{{n}_{D} ( r )} \frac{1}{1 + {e}^{- h ( s , r )} } \\ {n}_{CP} ( s , r ) \frac{1}{1 + {e}^{h ( s , r )}} = \sqrt{{n}_{D} ( s )} \sqrt{{n}_{D} ( r )} \frac{1}{1 + {e}^{- h ( s , r )}} \\ \frac{{n}_{CP} ( s , r )}{\sqrt{{n}_{D} ( s )} \sqrt{{n}_{D}} ( r )} = \frac{1 + {e}^{h ( s , r )}}{1 + {e}^{- h ( s , r )}} \qquad Equation 13$$

Applying the fact that

$$\frac{1 + {e}^{x}}{1 + {e}^{- x}} = {e}^{x} ,$$

the value of h(s,r) that minimizes Equation 11 is:

$$h ( s , r ) = log [ \frac{{n}_{CP} ( s , r )}{\sqrt{{n}_{D} ( s )} \sqrt{{n}_{D} ( r )}} ] \qquad Equation 14$$

which is the log of Equation 7.

In some embodiments, the cardinality of the set I×I may be too large to explicitly enumerate. As an alternative to optimizing Equation 10, a Monte Carlo estimate may be optimized. A normalization factor can be defined as [symbol] ≡Σ_{t∈I}\sqrt{n_{D}(t)}. Let k_{CP} be the number of co-purchased item pairs sampled according to the distribution

$${P}_{CP} ( s , r ) = \frac{{n}_{CP} ( s , r )}{\vert CP \vert} .$$

Let kₛ be the number of seed items sampled as negative examples according to the distribution

$$P \begin{matrix}√ \\ D\end{matrix} ( s ) = \frac{\sqrt{{n}_{D} ( s )}}{𝓏} ,$$

and let kᵣ be the number of candidate items sampled as negative examples for each negative seed item according to the distribution P_{D}^{√}(r). In this example, s and r may be drawn independently from the distribution P_{D}^{√}. The Monte Carlo estimate of the cost function in Equation 10 can then be defined as:

$${𝓁}_{MC} = \begin{matrix}𝔼 \\ ( s , r ) \sim {P}_{CP}\end{matrix} [ {k}_{CP \cdot lo g σ ( h ( s , r ) )} ] + \begin{matrix}𝔼 \\ {s}^{′} \sim P \begin{matrix}√ \\ D\end{matrix}\end{matrix} \begin{matrix}𝔼 \\ {r}^{′} \sim P \begin{matrix}√ \\ D\end{matrix}\end{matrix} [ {k}_{s} \cdot {k}_{r} \cdot log σ ( - h ( {s}^{′} , {r}^{′} ) ) ] \qquad Equation 15$$

and the expectations may be explicitly expressed as follows:

$${𝓁}_{MC} = {\sum }_{( s , r ) ∈ CP} [ \frac{{n}_{{CP}^{( s , r )}}}{\vert CP \vert} {k}_{CP} log σ ( h ( s , r ) ) ] + {\sum }_{{s}^{′} ∈ l} {\sum }_{{r}^{′} ∈ l} [ \frac{\sqrt{{n}_{{D}^{( {s}^{′} )}}}}{𝒵} \frac{\sqrt{{n}_{{D}^{( {s}^{′} )}}}}{𝒵} {k}_{s} {k}_{r} log σ ( - h ( {s}^{′} , {r}^{′} ) ) ] \qquad Equation 16$$

Then, for a specific pair of items (s,r):

$${𝓁}_{MC} ( s , r ) = {n}_{CP} ( s , r ) \frac{{k}_{CP}}{\vert CP \vert} log σ ( h ( s , r ) ) + \sqrt{{n}_{D} ( s )} \sqrt{{n}_{D} ( r )} \frac{{k}_{s}}{𝒵} \frac{{k}_{r}}{𝒵} log σ ( - h ( s , r ) ) \qquad Equation 17$$

Using the same methods used to derive Equation 14 above, the derivative of [symbol] _{MC}(s,r) with respect to h(s,r) can be computed and solved for h(s,r):

$$\frac{\partial {𝓁}_{MC} ( s , r )}{\partial h ( s , r )} = {n}_{CP} ( s , r ) \frac{{k}_{CP}}{\vert CP \vert} σ ( - h ( s , r ) ) - \sqrt{{n}_{D} ( s )} \sqrt{{n}_{D} ( r )} \frac{{k}_{s} {k}_{r}}{{𝒵}^{2}} σ ( h ( s , r ) ) \qquad Equation 18$$

Solving Equation 18 for h(s,r) provides:

$$h ( s , r ) = log [ \frac{{n}_{CP} ( s , r )}{\sqrt{{n}_{D} ( s ) \sqrt{{n}_{D} ( r )}}} ] + log [ \frac{{k}_{CP}}{{k}_{s} {k}_{r}} ] + log [ \frac{{𝒵}^{2}}{\vert CP \vert} ] \qquad Equation 19$$

Equation 19 indicates that the output of the model h(s,r) that optimizes the cost function in Equation 15 is the cosine similarity shifted by a constant proportional to the ratio of the sampling mixture of positive and negative examples, and the ratio of the number of co-purchases in the training set and the number of purchases.

In some embodiments, an additional simplification can be used to train the models based on a negative sampling loss. To do so, the (s,r) pairs can be sampled from P_{CP} as described above. However, instead of sampling from the Cartesian product of items (s′,r′) over D×D according to P_{D}^{√}, k examples are only sampled from P_{D}^{√} for every s corresponding to an (s,r) pair sampled from P_{CP}:

$${𝓁}_{NEG} = \begin{matrix}𝔼 \\ ( s , r ) \sim {P}_{CP}\end{matrix} ( log σ ( h ( s , r ) ) ) + \begin{matrix}𝔼 \\ {r}^{′} \sim P \begin{matrix}√ \\ D\end{matrix}\end{matrix} [ {k}_{r} \cdot log σ ( - h ( s , {r}^{′} ) ) ] \qquad Equation 20$$

Each of equations 15 and 20 require sampling according to the probability distribution P_{D}^{√}. In an inventory with a heavy tail (there are a minority of items that are very popular and a majority of items that are purchased only a few times), optimizing the cost functions represented by equations 15 and 20 requires samples of every item in the distribution. However, if samples are only taken according to P_{D}^{√}, it is much more likely to sample the minority of popular items than the majority of rarer items. When a model is trained in this way some of the heavy tail is missed, the quality of recommendations suffer because when the model is evaluating an item for recommendation in production and that item has never been seen during training (because something similar to it was not sampled), the output of the model may be inaccurate. Although the model can be trained for a much longer period of time (e.g., weeks or months), it is impractical to do so.

Instead, the loss functions in Equations 15 and 20 can be modified so they still converge to the log of the cosine similarity, but do not rely on sampling according to P_{CP} and P_{D}^{√}. Instead, samples can be selected such that they are maximally diverse. In other words, many samples will be sampled such that each sample is as dissimilar as possible from every other example. The loss functions can then be modified so that instead of relying on sampling, it instead relies on weighting the two terms in the loss function.

For example, assume yₘ refers to the maximally diverse subset of items of size m, and Equation 20 can be modified as (where K is a normalization factor):

$${𝓁}_{NEG \text{-} UNI} = \begin{matrix}𝔼 \\ ( s , r ) \sim {P}_{CP}\end{matrix} ( log σ ( h ( s , r ) ) + \begin{matrix}𝔼 \\ {r}^{′} ∈ {y}_{m}\end{matrix} [ 𝒦 \cdot P \begin{matrix}√ \\ D\end{matrix} ( {r}^{′} ) \cdot {k}_{r} \cdot log σ ( - h ( s , {r}^{′} ) ) ] ) \qquad Equation 21$$

In another example, assume yₘ refers to the maximally diverse subset of items of size m, and Equation 15 can be modified as:

$${l}_{UNI} = \begin{matrix}Σ \\ s ∈ {y}_{m}\end{matrix} \begin{matrix}Σ \\ r ∈ {y}_{m}\end{matrix} ( {P}_{CP} ( s , r ) log σ ( h ( s , r ) ) + P \begin{matrix}√ \\ D\end{matrix} ( s ) \cdot P \begin{matrix}√ \\ D\end{matrix} ( r ) \cdot log σ ( - h ( s , r ) ) ) \qquad Equation 22$$

In each of Equations 21 and 22, y can be constructed using a number of sampling techniques. Initially, the items in the list of items may be represented by a list of token IDs. A vectorization scheme maps the items into a low dimensional feature space and a vectorization function maintains the distances in the original space.

In a binary quantization embodiment, items are quantized to space {0,1}^{Q}. The quantization may be accomplished by random hyperlane projection. In one embodiment, quantization be efficiently implemented without explicitly transferring token IDs to bag-of-words representation. In a MinHash embodiment, a more compressed signature can be accomplished than quantization, which results in less collisions. In a maximum-mixed method (Max-MM) diverse sampling embodiment, a sampling algorithm iteratively adds the most diverse item to the sample set. The diversity of an item i to the subset S is defined as a form of nearest neighbor:

Diversity(i,S)=min_{j∈s}dist(i,j) Equation 23

To add an item, the algorithm randomly samples C items as candidates, and picks the one with the highest diversity. In one embodiment, Faiss may be utilized for finding approximate nearest neighbors (ANNs). The implementation may be based on the cell-probe method (ncentroids=256, nprobe=10) with inverted file system (IVF) and product quantization (PQ).

In a collision-based sampling (CBS) embodiment, locality-sensitive hashing obviates the need for ANN. Instead, similar items are mapped to the same buckets with high probability. After preprocessing, a set of hashing codes E is used to collect the buckets of the selected items. Here, a hashing code for item i is said to be the concatenation of the existing hashing functions (buckets): H(i)=<h₁(i), . . . , h_{|H|}(i)>. The algorithm starts with only one hashing function, (i.e., |H|=1). For each iteration, within M times of trials, the algorithm adds an item i if there is no collision with the existing items, (i.e. Hash(i)∉E). Otherwise, an additional hashing function is added to resolve a collision.

In one embodiment, a multi-table method is applied to the CBS embodiment. The algorithm hashes the input into T tables where each table is a concatenation of k buckets (hash functions). A randomly selected item is accepted if it has at least θ non-collision tables. θ is initialized to be T and θ←θ−1 if the algorithm is not able to find an eligible item within M times of trials. The algorithm fails when θ is decreased to θ.

In some instances, in evaluating a trained model, the training component 240 selects a period of time or a time range of co-interacted network asset pairs. The period of time or time range may be disjointed from the set of pairs used within the training dataset. For example, if training on network asset pairs occurring between Jan. 1, 2015 and Dec. 31, 2015, a validation set may be selected by the training component 240 for network assets with which users interacted between Jun. 1, 2016 and Jun. 30, 2016. In some instances, a specified number of co-interacted network asset pairs may be selected from the validation set. For example 1,000 co-interacted network asset pairs may be selected from the time period associated with the time range for the validation set. In some embodiments, for each seed network asset in each of the network asset pairs, the training component 240 samples n network assets that were live on the networked system 102, the third party servers 130, or any other suitable database, server, or system accessible by the interaction prediction system 142. In some instances, the n network assets sampled by the training component 240 were not yet listed in the period of time designated for the training dataset. The training component 240 may then rank n+1 network assets according to an output of the neural network, using the trained model under evaluation. The training component 240 may then examine a distribution of the position of the network assets with which users or a specified user co-interacted in the ranked n+1 list of network assets. For example, actual co-interaction data from the interaction table may be used to examine the distribution. The training component 240 may then select a trained model having a highest mean rank and having a rank variance that is lowest across the 1,000 seed network assets.

In some embodiments, one or more of the modeling component 230 and the training component 240 may modify models to estimate the cosine similarity or approximate the conditional probability, P(xᵣ|xₛ), without enumerating or normalizing over a space of all possible recommendation candidate network assets, xᵣ. In such embodiments, the components may model instances in which an item might be more likely to be co-interacted with a specified network asset than another. In some instances, models may assign low or relatively low probabilities to network asset pairs which did not occur during training. In such instances, the models may not employ the heuristic filter.

In some embodiments, the interaction prediction system 142 averages title and aspect embeddings together. The interaction prediction system 142 may also use additional methods, variations of methods, additional operations, additional neural network layers, and other suitable alterations to model relationships between tokens. For example, the interaction prediction system 142 may use word or character-level convolutional neural networks, in some instances. The interaction prediction system 142 may also employ recurrent neural networks for titles and other inputs to the interaction prediction system 142. Although some embodiments above are described with initial layers of a neural network, in some instances, the modeling component 230 or the training component 240 may operate without employing one or more top layers described above. In such embodiments, the components may identify, learn, or model embeddings such that network assets with high co-interaction probabilities have small Euclidean or Cosine distances among them. The network assets having low co-interaction probabilities may have large or relatively larger Euclidean or Cosine distances among them.

In some instances, the neural networks employ image analysis, image recognition, and other image learning operations in one or more neural network layers, or a separate neural network having outputs integrated with the neural network employed by one or more of the modeling component 230 and the training component 240. In these embodiments, the interaction prediction system 142 jointly learns text representations and image representations in determining or estimating co-interaction probabilities. In some instances, metric learning approaches may also be incorporated in one or more of the methods or embodiments described herein for modeling scoring functions (e.g., cosine similarity estimates or conditional probabilities, P(xᵣ|xₛ)).

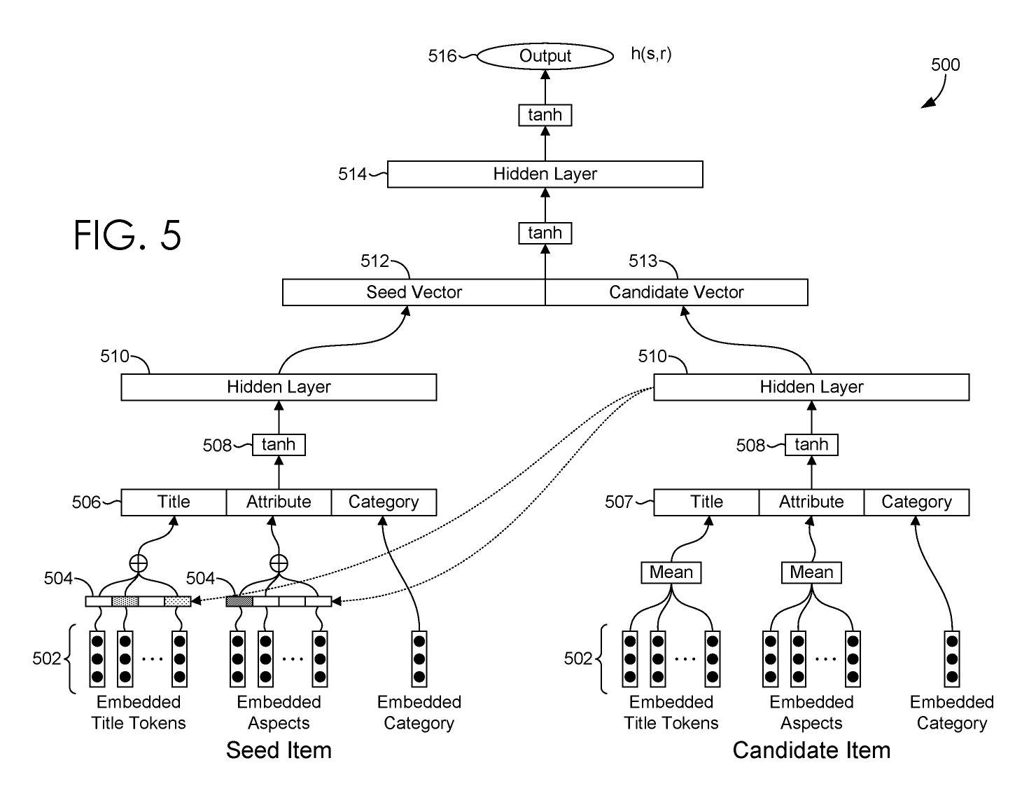

FIG. 5 is a block diagram illustrating a neural network architecture 500 of the interaction prediction system 142, according to some example embodiments. As shown in FIG. 5, input to the neural network 500 may consist of titles, identifications, and designations of network assets (e.g., items). The input may also include aspects and categories for network assets or pairs of network assets. As shown, the network may be composed of five layers. In a first layer, tokens representing or included in titles, aspects, and categories of two network assets are retrieved in an embedding table. The modeling component 230 retrieves embedding vectors 502 associated with the tokens. Rather than an average pooling layer performing an element-wise unweighted averaging of the title vectors and aspects for each network asset, as illustrated in FIG. 4, in embodiments, the average pooling layer performs an element-wise weighted averaging of the title vectors and aspects 504 for each network asset. For example, suppose that the seed item is a 15-by-20 inch print of a Van Gogh painting. If the recommendation candidate is a picture frame, then the most important property of the seed item for making a recommendation is the fact that it is 15-by-20 inches. However, if the recommendation candidate is another painting, then the most important property of the seed is the artist. To that end, at the average pooling layer, a learned weighted average can be utilized where the weights are conditioned on the embedding of the recommendation candidate. Note that although FIG. 2 is illustrated to show the attention mechanism applying to the seed item and conditioned on the recommendation, in some embodiments, the attention mechanism is applied to the candidate item and is bidirectional.

As described in FIG. 4, the averaged vectors may then be concatenated together for the seed network asset 506 and the candidate network asset 507. The averaged and concatenated vectors may be passed through a non-linearity function or layer, such as a hyperbolic tangent function 508 or a neural network layer employing a hyperbolic tangent function, and be fed through a fully connected layer 510. The averaged and concatenated vectors or results produced by the fully connected layer may be fed through another non-linearity function or layer. The pass through the subsequent fully connected layer may yield a semantic vector representation for the seed item 512 and a semantic vector representation for the candidate item 513. The two representations may then be concatenated and fed through two fully connected layers with non-linearities 514. The output 516 of the two fully connected layers may represent a prediction for a probability of a co-interaction (e.g., a co-purchase) of the seed network asset and the candidate network asset.

In some embodiments, to train the model, the training component 240 may receive or access a set of training data to generate an initial or trained model. In some instances, the training component 240 trains the initial model independently. The training component 240 may also train the initial model in cooperation with the modeling component 230. In some instances, the training component 240 is a part or component of the modeling component 230. In such embodiments, the training component 240 may be a component configured to be isolated from operations of the modeling component 230 performed outside of training or performed on data determined to be excluded from the set of training data.

The training component 240 may initially train the initial model to predict a probability of interaction (i.e., a scoring function) with a recommended candidate network asset xᵣ given an initial interaction with a seed network asset xₛ. The scoring function may be represented as a cosine similarity estimate or a conditional probability P(xᵣ|xₛ). The scoring function generated by the initial model, or the model trained by the modeling component 230, may be used to rank, select, or generate probability values indicative of co-interactions between a given first network asset and a given second network asset. In some instances, the scoring function may indicate a likelihood of purchase, bidding, viewing, selection, reading, or any other suitable interaction or combination of interactions.

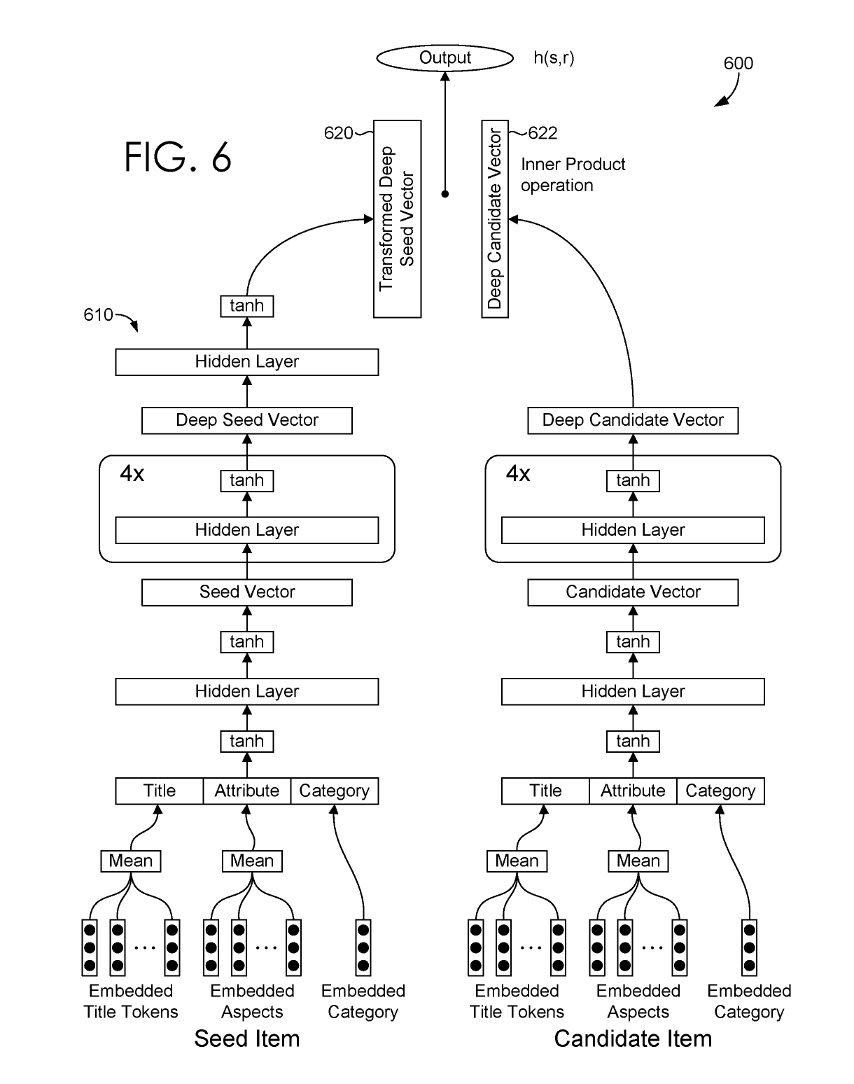

FIG. 6 is a block diagram illustrating a neural network architecture 600 of the interaction prediction system 142, according to some example embodiments. As shown in FIG. 6, input to the neural network 600 may consist of titles, identifications, and designations of network assets (e.g., items). In FIGS. 4 and 5, the seed and candidate vectors are concatenated and then some fully-connected layers are executed on top of the resulting concatenated vector. This is done because the seed item and the candidate item are embedded in two different vector spaces (i.e., they are parameterized separately since model parameters are not shared between them). However, in FIG. 6, the neural network 600 is modified to transform 610 the seed vector into the recommendation candidate space 620. Instead of concatenating the two vectors, an inner product between the transformed seed vector 620 and candidate vector 622 can provide the recommendation score. This allows ANN methods (e.g., locality-sensitive hashing or product quantization) to retrieve candidates, which changes the prediction that is quadratic in the number of items to one that is linear in the number of items.

In some embodiments, to train the model, the training component 240 may receive or access a set of training data to generate an initial or trained model. In some instances, the training component 240 trains the initial model independently. The training component 240 may also train the initial model in cooperation with the modeling component 230. In some instances, the training component 240 is a part or component of the modeling component 230. In such embodiments, the training component 240 may be a component configured to be isolated from operations of the modeling component 230 performed outside of training or performed on data determined to be excluded from the set of training data.

The training component 240 may train the initial model to predict a probability of interaction (i.e., a scoring function) with a recommended candidate network asset xᵣ given an initial interaction with a seed network asset xₛ. The scoring function may be represented as a cosine similarity estimate or a conditional probability P(xᵣ|xₛ). The scoring function generated by the initial model, or the model trained by the modeling component 230, may be used to rank, select, or generate probability values indicative of co-interactions between a given first network asset and a given second network asset. In some instances, the scoring function may indicate a likelihood of purchase, bidding, viewing, selection, reading, or any other suitable interaction or combination of interactions.

### Machine and Software Architecture

The components, methods, applications and so forth described in conjunction with FIGS. 2-6 are implemented in some embodiments in the context of a machine and an associated software architecture. In various embodiments, the components, methods, applications and so forth described above are implemented in the context of a plurality of machines, distributed across and communicating via a network, and one or more associated software architectures. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

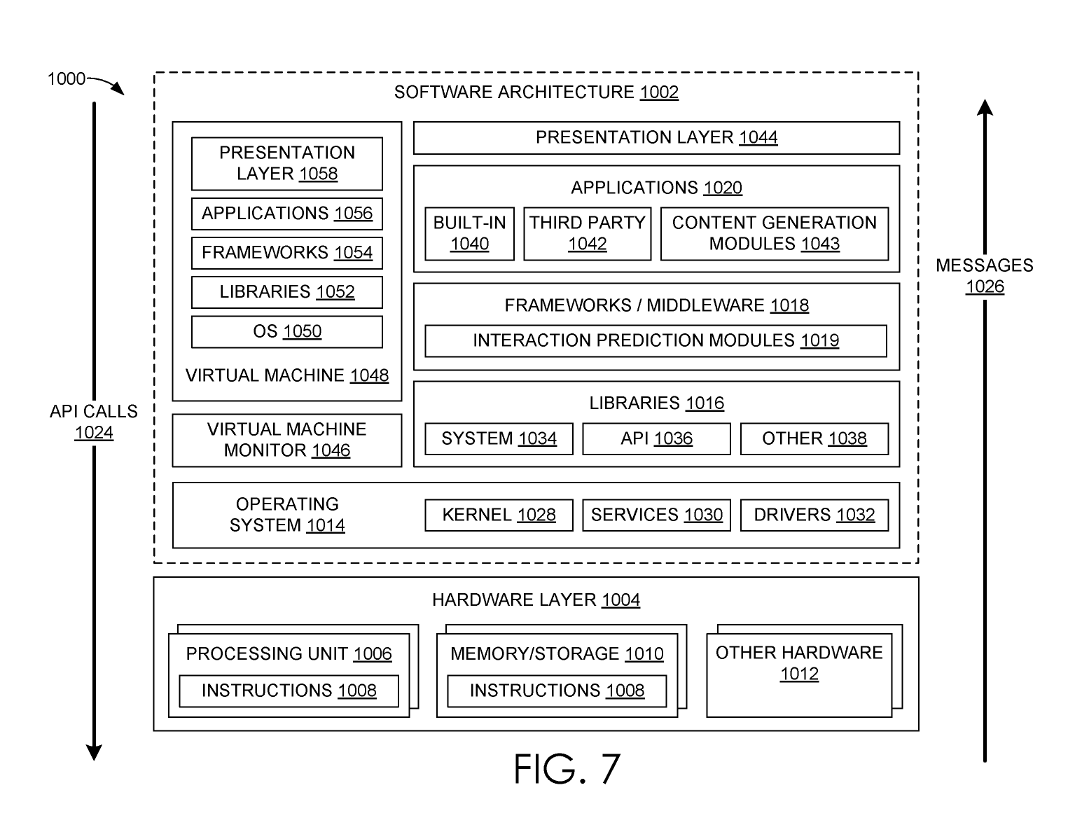

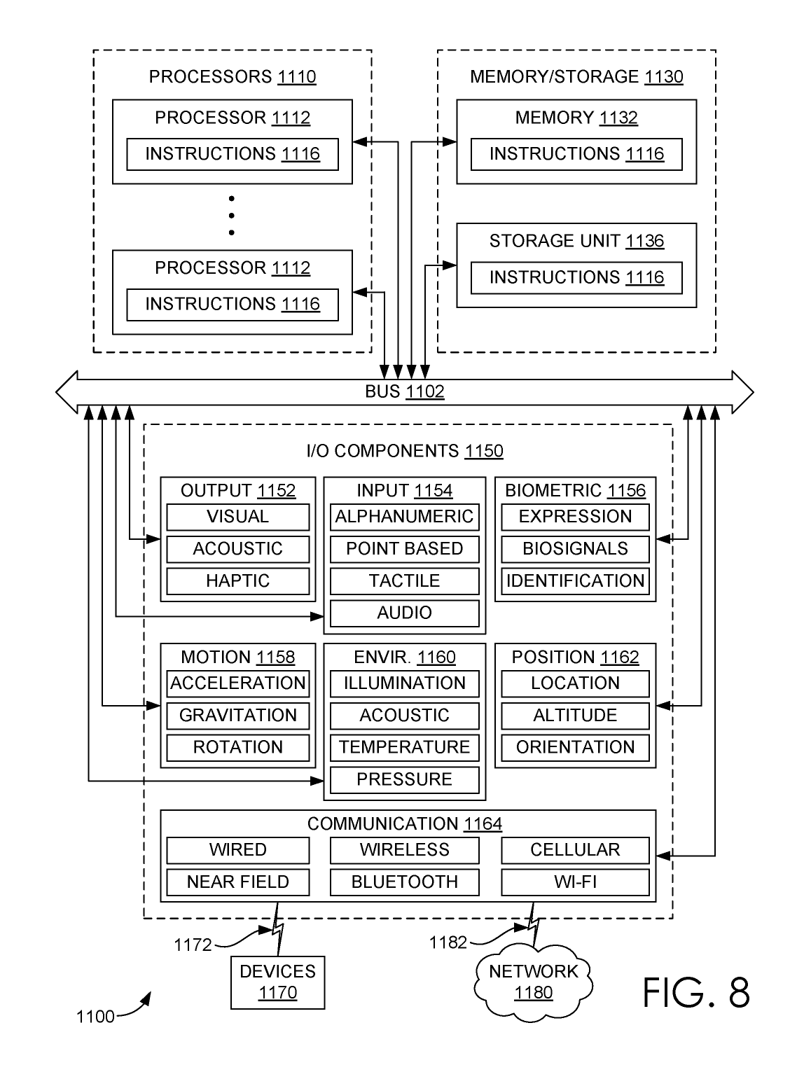

FIG. 7 is a block diagram 1000 illustrating a representative software architecture 1002, which may be used in conjunction with various hardware architectures herein described. FIG. 7 is merely a non-limiting example of a software architecture and it will be appreciated that many other architectures may be implemented to facilitate the functionality described herein. The software architecture 1002 may be executing on hardware such as machine 1100 of FIG. 8 that includes, among other things, processors 1110, memory 1130, and I/O components 1150. A representative hardware layer 1004 is illustrated and can represent, for example, the machine 1000 of FIG. 7. The representative hardware layer 1004 comprises one or more processing units 1006 having associated executable instructions 1008. Executable instructions 1008 represent the executable instructions of the software architecture 1002, including implementation of the methods, components and so forth of FIGS. 2-6. Hardware layer 1004 also includes memory and/or storage components 1010, which also have executable instructions 1008. Hardware layer 1004 may also comprise other hardware as indicated by 1012 which represents any other hardware of the hardware layer 1004, such as the other hardware illustrated as part of machine 1100.

In the example architecture of FIG. 7, the software 1002 may be conceptualized as a stack of layers where each layer provides particular functionality. For example, the software 1002 may include layers such as an operating system 1014, libraries 1016, frameworks/middleware 1018, applications 1020 and presentation layer 1022. Operationally, the applications 1020 and/or other components within the layers may invoke application programming interface (API) calls 1024 through the software stack and receive a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software components to perform tasks in an easier fashion than to interface directly with the underlying operating system 1014 functionality (e.g., kernel 1028, services 1030 and/or drivers 1032). The libraries 1016 may include system 1034 libraries (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform. In some example embodiments interaction prediction modules 1019 (e.g., one or more modules or components of the interaction prediction system 142) may be implemented at least in part within the middleware/frameworks 1018. For example, in some instances at least a portion of the presentation component 260, providing graphic and non-graphic user interface functions, may be implemented in the middleware/frameworks 1018. Similarly, in some example embodiments, portions of one or more of the access component 210, the identification component 220, the modeling component 230, the training component 240, the generation component 250, and the presentation component 260 may be implemented in the middleware/frameworks 1018.

The applications 1020 includes built-in applications 1040, third party applications 1042, and/or interaction prediction modules 1043 (e.g., user facing portions of one or more of the modules or components of the interaction prediction system 142). Examples of representative built-in applications 1040 may include, but are not limited to, a contacts application, a browser application, a book reader application, a location application, a media application, a messaging application, and/or a game application. Third party applications 1042 may include any of the built in applications as well as a broad assortment of other applications. In a specific example, the third party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1042 may invoke the API calls 1024 provided by the mobile operating system such as operating system 1014 to facilitate functionality described herein. In various example embodiments, the user facing portions of the interaction prediction modules 1043 may include one or more components or portions of components described with respect to FIG. 2. For example, in some instances, portions of the access component 210, the identification component 220, the modeling component 230, the training component 240, the generation component 250, and the presentation component 260 associated with user interface elements (e.g., data entry and data output functions) may be implemented in the form of an application.

The applications 1020 may utilize built in operating system functions (e.g., kernel 1028, services 1030 and/or drivers 1032), libraries (e.g., system 1034, APIs 1036, and other libraries 1038), frameworks/middleware 1018 to create user interfaces to interact with users of the system. Alternatively, or additionally, in some systems interactions with a user may occur through a presentation layer, such as presentation layer 1044. In these systems, the application/component “logic” can be separated from the aspects of the application/component that interact with a user.

Some software architectures utilize virtual machines. In the example of FIG. 7, this is illustrated by virtual machine 1048. A virtual machine creates a software environment where applications/components can execute as if they were executing on a hardware machine (such as the machine of FIG. 8, for example). A virtual machine is hosted by a host operating system (operating system 1014 in FIG. 7) and typically, although not always, has a virtual machine monitor 1046, which manages the operation of the virtual machine as well as the interface with the host operating system (i.e., operating system 1014). A software architecture executes within the virtual machine such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Example Machine Architecture and Machine-Readable Medium

FIG. 8 is a block diagram illustrating components of a machine 1100, according to some example embodiments, able to read instructions (e.g., processor executable instructions) from a machine-readable medium (e.g., a non-transitory machine-readable storage medium) and perform any one or more of the methodologies discussed herein. Specifically, FIG. 8 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions may cause the machine to execute the flow diagrams of FIGS. 3 and 4. Additionally, or alternatively, the instructions may implement the access component 210, the identification component 220, the modeling component 230, the training component 240, the generation component 250, and the presentation component 260 of FIGS. 2-4, and so forth. The instructions transform the general, non-programmed machine into a particular machine programmed to carry out the described and illustrated functions in the manner described.

In alternative embodiments, the machine 1100 operates as a standalone device or may be coupled (e.g., networked) to other machines in a networked system. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), an entertainment media system, a web appliance, a network router, a network switch, a network bridge, or any machine capable of executing the instructions 1116, sequentially or otherwise, that specify actions to be taken by machine 1100. In some example embodiments, in the networked deployment, one or more machines may implement at least a portion of the components described above. The one or more machines interacting with the machine 1100 may comprise, but not be limited to a personal digital assistant (PDA), an entertainment media system, a cellular telephone, a smart phone, a mobile device, a wearable device (e.g., a smart watch), a smart home device (e.g., a smart appliance), and other smart devices. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 8 shows multiple processors, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 8. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, components, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method of generating notifications for second network assets contemporaneous with and based on user interactions with a first network asset, the method comprising:
receiving an indication of a user interaction with a first network asset, the first network asset being singular or unique;
identifying one or more characteristics of the first network asset;
training a model to maximize relevance between a first network asset and a set of second network assets, the model using semantic representations of the one or more characteristics of the first network asset to identify the set of second network assets;
utilizing the model to generate a set of probability values for the set of second network assets, each probability value indicating a likelihood of user interaction with a second asset of the set of second network assets; and
based on the set of probability values, surfacing a recommendation candidate, the recommendation candidate being at least a portion of the set of second network assets.

2. The method of claim 1, further comprising identifying co-interaction frequencies between static entities associated with the first network asset and one or more additional network assets.

3. The method of claim 2, wherein co-interactions comprise one or more of co-purchases, co-bids, co-views, subsequent views, or views-after purchase.

4. The method of claim 2, wherein the one or more additional network assets are provided as an initial input in generating the set of second network assets.

5. The method of claim 1, wherein the model learns which features are indicative of co-interaction without employing static entities or groupings.

6. The method of claim 1, wherein the first network asset is one or more of a database or a resource, such as a publication, an item in a repository of item listings, a portion of data stored on a database, or any other resource configured for user interaction.

7. The method of claim 1, wherein the indication of the user interaction may include an interaction type, the interaction type designating a type for the user interaction.

8. The method of claim 1, wherein the one or more characteristics comprise one or more of a title, an aspect, and a category designation.

9. The method of claim 1, further comprising generating the model without explicitly performing mapping operations prior to model generation.

10. The method of claim 9, wherein the model iteratively generates estimations of the relevance of recommendation candidates to the first network asset using the one or more characteristics of the first network as set.

11. The method of claim 1, wherein the recommendation candidate is surfaced substantially contemporaneously with the user interaction with the first network asset.

12. The method of claim 1, wherein the model utilizes a cost function that, when optimized, converges to the logarithm of the cosine similarity between implicit feedback vectors of the first network asset and the recommendation candidate.

13. The method of claim 12, wherein the set of second network assets is created using collision-based sampling and each term in the cost function is weighted.

14. The method of claim 1, wherein the model utilizes a cost function that, when optimized, converges to a Monte-Carlo estimate of the loss between implicit feedback vectors of the first network asset and the recommendation candidate.

15. The method of claim 14, wherein the set of second network assets is created using collision-based sampling and each term in the cost function is weighted.

16. The method of claim 1, wherein the model applies a learned weighted average to the first network asset that is conditioned on a second network asset of the set of second network assets.

17. The method of claim 1, wherein the model transforms the first network asset into a second network asset space and determine an inner product between the first network asset and a second network asset of the set of second network assets to determine the probability value.

18. The method of claim 1, wherein the model utilizes the semantic representations to identify the set of second network assets using k nearest neighbor analysis, algorithms, or operations.

19. A non-transitory computer storage medium storing computer-useable instructions that, when used by at least one computing device, cause the at least one computing device to perform operations for generating notifications for second network assets contemporaneous with and based on user interactions with a first network asset, comprising:
receiving an indication of a user interaction with a first network asset, the first network asset being singular or unique;
identifying one or more characteristics of the first network asset;
training a model to maximize relevance between a first network asset and a set of second network assets, the model using semantic representations of the one or more characteristics of the first network asset to identify the set of second network assets;
utilizing the model to generate a set of probability values for the set of second network assets, each probability value indicating a likelihood of user interaction with a second asset of the set of second network assets, the model applying a learned weighted average to the first network asset that is conditioned on a second network asset of the set of second network assets; and
based on the set of probability values, surfacing a recommendation candidate, the recommendation candidate being at least a portion of the set of second network assets.

20. A computerized system for generating notifications for second network assets contemporaneous with and based on user interactions with a first network asset, the system comprising:
at least one processor; and
computer readable memory storing computer usable instructions that, when executed by the at least one processor, cause the at least one processor to:
receive an indication of a user interaction with a first network asset, the first network asset being singular or unique;
identify one or more characteristics of the first network asset;
train a model to maximize relevance between a first network asset and a set of second network assets, the model using semantic representations of the one or more characteristics of the first network asset to identify the set of second network assets;
utilize the model to generate a set of probability values for the set of second network assets, each probability value indicating a likelihood of user interaction with a second asset of the set of second network assets, the model transforming the first network asset into a second network asset space and determining an inner product between the first network asset and the second network asset of the set of second network assets to determine the probability value; and
based on the set of probability values, surface a recommendation candidate, the recommendation candidate being at least a portion of the set of second network assets.
